(19) United States
(12) Patent Application Publication
(10) Pub. No.: US 2026/0261802 A1
(43) Pub. Date: Sep. 3, 2026

(54) CONTROL DEVICE FOR GLASS DIAPHRAGM MODULE, CONTROL SYSTEM, CONTROL METHOD FOR GLASS DIAPHRAGM MODULE, AND CONTROL PROGRAM

(71) Applicant: AGC Inc., Tokyo (JP)

(72) Inventor: Kento SAKURAI, Tokyo (JP)

(73) Assignee: AGC Inc., Tokyo (JP)

(21) Appl. No.: 19/653,774

(22) Filed: Apr. 21, 2026

Related U.S. Application Data
(63) Continuation of application No. PCT/JP2024/035852, filed on Oct. 7, 2024.

(30) Foreign Application Priority Data
Oct. 25, 2023 (JP) 2023-183513

(51) Int. Cl. H04R 7/06; H04R 3/00

(52) U.S. Cl. CPC H04R 7/06; H04R 3/00; H04R 2499/13

(57) ABSTRACT

A control device for a glass diaphragm module includes: a generation unit that generates a control signal for causing a glass diaphragm module to generate sound on the basis of parameters; an output unit that outputs the control signal to the glass diaphragm module; and a setting unit that sets the parameters on the basis of temperature-related information related to a temperature of the glass diaphragm module.

### CROSS-REFERENCE TO RELATED APPLICATIONS

This application is a continuation application of International Application No. PCT/JP2024/035852, filed Oct. 7, 2024, the disclosure of which is incorporated herein by reference in its entirety. Further, this application claims priority under 35 USC 119 from Japanese Patent Application No. 2023-183513 filed Oct. 25, 2023, the disclosure of which is incorporated by reference herein.

### TECHNICAL FIELD

The present disclosure relates to a control device for a glass diaphragm module, a control system, a control method for a glass diaphragm module, and a control program.

### BACKGROUND ART

International Publication No. WO 2022/244748 discloses a vibration device including: a glass diaphragm formed by laminating a plurality of glass plates and having a solid-phase intermediate layer between at least a pair of glass plates among the glass plates; an exciter fixed to the glass diaphragm and configured to vibrate the glass diaphragm; and a surrounding member defining an internal space in which the exciter fixed to the glass diaphragm is surrounded and having one end of the glass diaphragm exposed to the outside of the internal space from an opening portion of the internal space, in which the glass diaphragm includes a temperature adjustment unit configured to adjust a temperature of the intermediate layer.

International Publication No. WO 2022/158542 discloses a sound insulation device including: a glass plate structure formed by laminating a plurality of glass plates, including an intermediate layer between at least a pair of glass plates among the glass plates, and partitioning an indoor space and an outdoor space; a vibration output unit fixed to the glass plate structure and configured to vibrate the glass plate structure in accordance with an input signal; an outdoor sound detection unit configured to detect sound from a noise source or a vibration source correlated with a sonic vibration induced in the glass plate structure and output a reference signal in accordance with a detection result; an indoor sound detection unit configured to detect sound in the indoor space and output an error signal in accordance with a detection result; and a control unit including an adaptive filter that generates a cancellation signal in a phase opposite to that of the reference signal so that the error signal is minimized and configured to cause the vibration output unit to output the cancellation signal from the adaptive filter.

### SUMMARY OF INVENTION

### Technical Problem

In general, a glass diaphragm module is configured to include, in addition to a glass plate and an exciter connected to the glass plate, various resin members formed of, for example, plastic, rubber, or the like. The resin members have higher rates of change in mechanical characteristics (for example, elastic moduli, attenuation rates, and the like) with respect to a temperature change than the glass plate. There is a concern that if the mechanical characteristics of the resin members change in accordance with the temperature, frequency response of the resin members may change, vibration characteristics (for example, acceleration, an amplitude value, or the like of vibration for each frequency) of the glass plate may be affected, and performance of the glass diaphragm module may thus change. In other words, there is a concern that an error may occur between sound assumed to be emitted from the glass plate in a case where a control signal is input to the exciter and sound actually emitted from the glass plate. Such a situation may occur in a case where the temperatures of members other than the resin members (for example, metal members or the like formed of various metals) among members included in the glass diaphragm module change and mechanical characteristics of the members change.

An object of the present disclosure is to provide a control device for a glass diaphragm module, a control system, a control method for a glass diaphragm module, and a control program capable of curbing a change in performance of the glass diaphragm module in accordance with a temperature.

### Solution to Problem

A first aspect of the present disclosure is a control device for a glass diaphragm module including: a generation unit that generates a control signal for causing the glass diaphragm module to generate sound on the basis of parameters; an output unit that outputs the control signal to the glass diaphragm module; and a setting unit that sets the parameters on the basis of temperature-related information related to a temperature of the glass diaphragm module.

A second aspect of the present disclosure is a control system including: the control device for a glass diaphragm module according to the first aspect; and the glass diaphragm module.

A third aspect of the present disclosure is a control method for a glass diaphragm module including: generating a control signal for causing the glass diaphragm module to generate sound on the basis of parameters; outputting the control signal to the glass diaphragm module; and setting the parameters on the basis of temperature-related information related to a temperature of the glass diaphragm module.

A fourth aspect of the present disclosure is a control program that causes a computer to execute processing including: generating a control signal for causing a glass diaphragm module to generate sound on the basis of parameters;

outputting the control signal to the glass diaphragm module; and setting the parameters on the basis of temperature-related information related to a temperature of the glass diaphragm module.

### Advantageous Effects of Invention

According to the present disclosure, a control device for a glass diaphragm module, a control system, a control method for a glass diaphragm module, and a control program, which are capable of curbing a change in performance of the glass diaphragm module in accordance with a temperature are provided.

### BRIEF DESCRIPTION OF DRAWINGS

FIG. 1 is a diagram illustrating a mode in which a control system according to a first embodiment is applied to a vehicle.

FIG. 2 is a sectional view illustrating a part of a glass diaphragm module according to the first embodiment.

FIG. 3 is a sectional view illustrating another part of the glass diaphragm module according to the first embodiment.

FIG. 4 is a block diagram illustrating a hardware configuration of the control system according to the first embodiment.

FIG. 5 is a block diagram illustrating a functional configuration of a control device according to the first embodiment.

FIG. 6 is a diagram for explaining operations of the control device according to the first embodiment.

FIG. 7 is a diagram illustrating an ANC map according to the first embodiment.

FIG. 8 is a diagram illustrating an audio map according to the first embodiment.

FIG. 9 is a flowchart illustrating a flow of control processing according to the first embodiment.

FIG. 10 is a sectional view illustrating a modification example of the glass diaphragm module according to the first embodiment.

FIG. 11 is a block diagram illustrating a hardware configuration of a control system according to a second embodiment.

FIG. 12 is a block diagram illustrating a functional configuration of a control device according to the second embodiment.

FIG. 13 is a diagram for explaining operations of the control device according to the second embodiment.

FIG. 14 is a flowchart illustrating a flow of update processing according to the second embodiment.

FIG. 15 is a sectional view illustrating another part of a glass diaphragm module according to a third embodiment.

FIG. 16 is a block diagram illustrating a hardware configuration of a control system according to the third embodiment.

FIG. 17 is a diagram for explaining operations in control processing of a control device according to the third embodiment.

FIG. 18 is a diagram for explaining operations in update processing of the control device according to the third embodiment.

FIG. 19 is a block diagram illustrating a hardware configuration of a control system according to a fourth embodiment.

FIG. 20 is a block diagram illustrating an example of a hardware configuration of a control system according to a fifth embodiment.

FIG. 21 is a diagram illustrating a mode in which a control system according to a sixth embodiment is applied to a building.

FIG. 22 is a perspective view illustrating a window glass according to the sixth embodiment.

### DESCRIPTION OF EMBODIMENTS

### First Embodiment

First, a first embodiment of the present disclosure will be described.

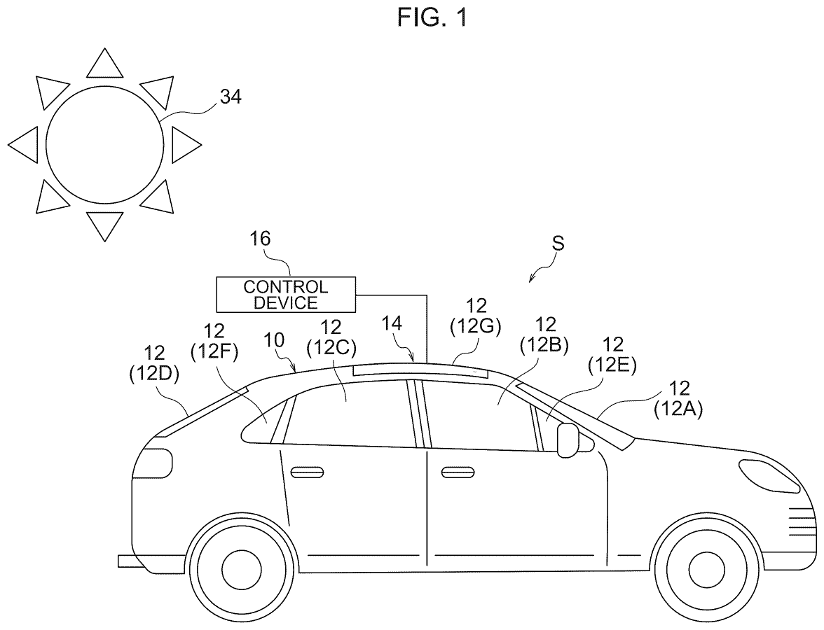

FIG. 1 illustrates a control system S according to the first embodiment. The control system S is applied to a vehicle 10 as an example. The vehicle 10 is a passenger car, for example. The vehicle 10 includes a plurality of glasses 12. The plurality of glasses 12 are located between an indoor space and an outdoor space of the vehicle 10 and partition the indoor space and the outdoor space.

The plurality of glasses 12 include a front window glass 12A, front side window glasses 12B, rear side window glasses 12C, a rear window glass 12D, front quarter window glasses 12E, rear quarter window glasses 12F, and a roof glass 12G. Note that the vehicle 10 may include other glasses in addition to the above glasses.

The control system S includes a glass diaphragm module 14 and a control device 16. The glass diaphragm module 14 is applicable to at least any glass 12 among the plurality of glasses 12 mounted on the vehicle 10. In the first embodiment, the glass diaphragm module 14 is applied to the roof glass 12G as an example. The roof glass 12G is provided on a roof of the vehicle 10.

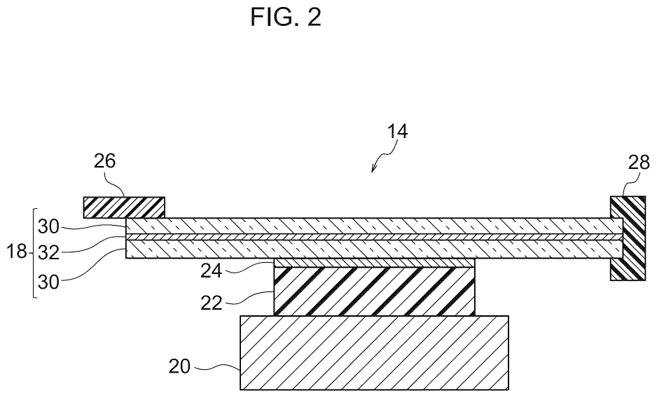

FIG. 2 illustrates a part of the glass diaphragm module 14 according to the first embodiment. The glass diaphragm module 14 includes a glass diaphragm 18, an exciter 20, a mount member 22, an adhesive layer 24, an adhesive member 26, and a fixation member 28.

The glass diaphragm 18 may be made of a single plate glass or may be made of laminated glasses. In the example illustrated in FIG. 2, the glass diaphragm 18 is made of laminated glasses. In other words, the glass diaphragm 18 includes a pair of glass plates 30 and an intermediate layer 32. The intermediate layer 32 is provided between the pair of glass plates 30. Note that the laminated glasses may be configured to have three or more glass plates 30.

The glass plates 30 may be formed of inorganic glass or organic glass. Examples of the organic glass include polymethyl methacrylate (PMMA)-based plastic, polycarbonate (PC)-based plastic, polystyrene (PS)-based plastic, polyethylene terephthalate (PET)-based plastic, polyvinyl chloride (PVC)-based plastic, and cellulose-based plastic.

In a case where the glass plates 30 are formed of inorganic glass, the glass plates 30 may be untempered glass or tempered glass. The untempered glass is glass obtained by forming molten glass into a plate shape and slowly cooling the glass. The tempered glass is glass obtained by forming a compressive stress layer on a surface of untempered glass and may be either air-cooled tempered glass or chemically tempered glass. The glass plates 30 may have a nature of absorbing ultraviolet rays or infrared rays.

The intermediate layer 32 is, for example, an ultraviolet absorbing film. The intermediate layer 32 is formed of, for example, polyvinyl butyral (PVB)-based plastic, ethylene vinyl acetate (EVA)-based plastic, thermoplastic polyurethane elastomer (TPU)-based plastic, polyethylene terephthalate (PET)-based plastic, silicone resin, or the like. The intermediate layer 32 may be a light adjustment film. Note that instead of the intermediate layer 32, a fluid layer or a gel-like body containing liquid may be used. The glass diaphragm 18 may be transparent or may be colored to an extent that transparency is not impaired.

The mount member 22 is fixed to a main surface on one side of the glass diaphragm 18 via the adhesive layer 24. The adhesive layer 24 may be formed using a resin such as plastic or rubber as a main component. For the adhesive layer 24, an adhesive may be used, or an adhesive tape, an adhesive film, or the like may be used.

The mount member 22 may be formed of, for example, a metal such as stainless steel, aluminum, an aluminum alloy, titanium, or a titanium alloy, or may be formed of a resin such as plastic or rubber. The plastic used for the mount member 22 may be general engineering plastic such as an ABS type, a PVC type, a PC type, a PP type, a PBT type, a PA66 type, or a PPS type, or may be fiber-reinforced plastic containing glass fiber or carbon fiber. In the first embodiment, the mount member 22 is formed of a resin such as plastic or rubber as an example. The mount member 22 may be formed of an adhesive or a pressure-sensitive adhesive.

The exciter 20 is fixed to a surface of the mount member 22 on a side opposite to the glass diaphragm 18. The exciter 20 may be fixed to the mount member 22 by a fastening component such as, for example, a bolt, a screw, a pin, a key, a rivet, or a clip in a replaceable manner. Note that the exciter 20 may be fixed to the main surface on the one side of the glass diaphragm 18 without the mount member 22 and the adhesive layer 24.

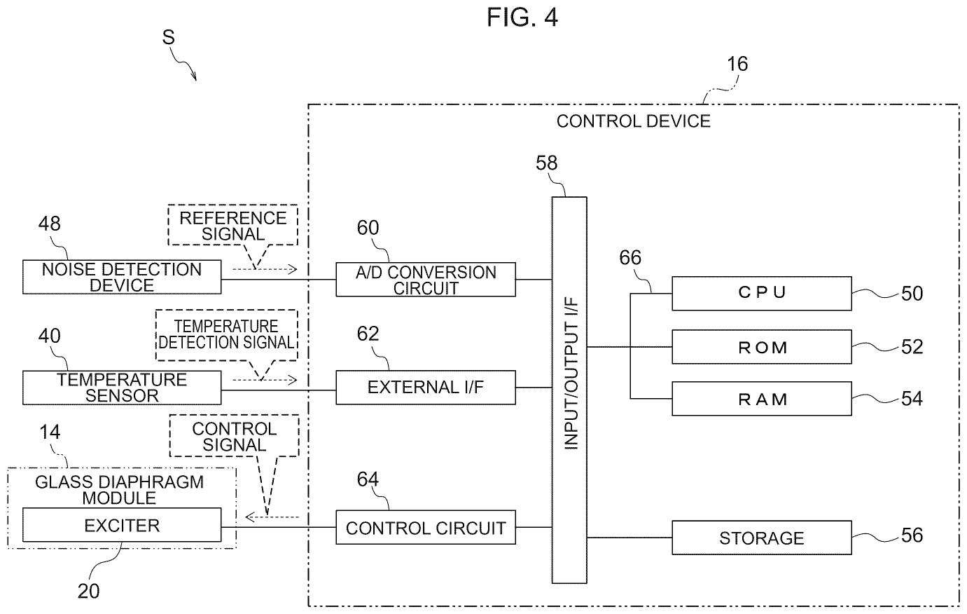

The exciter 20 is connected to a control circuit 64 (see FIG. 4), which will be described later, and causes the glass diaphragm 18 to vibrate in accordance with a control signal input from the control circuit 64. An example of the exciter 20 is a voice coil-type actuator. The voice coil-type actuator includes a coil (not illustrated) and a magnetic circuit (not illustrated). One of the coil and the magnetic circuit is fixed to the mount member 22, and the other is arranged to be movable relative to the mount member 22. Then, vibration is caused by an interaction between the coil and the magnetic circuit by a current flowing through the coil in accordance with the control signal, and the vibration of the exciter 20 is transmitted to the glass diaphragm 18 via the mount member 22. In this manner, the glass diaphragm 18 vibrates, and sound is generated from the glass diaphragm 18.

Note that the actuator used for the exciter 20 can be selected from any type of actuators capable of vibrating the glass diaphragm 18, such as a voice coil-type actuator or a piezo-type actuator. In addition, a device vibrating the glass diaphragm 18 is not limited to the actuator as long as an acoustic output can be achieved by vibrating the glass diaphragm 18.

The adhesive member 26 is a member for bonding the glass diaphragm 18 to a vehicle body, a frame member, a cover member, or the like. The adhesive member 26 may be formed using a resin such as plastic or rubber as a main component. For the adhesive member 26, an adhesive may be used, or an adhesive tape, an adhesive film, or the like may be used. Instead of the adhesive member 26 or in addition to the adhesive, a clip, a fastening member, or the like may be used. The fixation member 28 is a member fixed to the glass diaphragm 18. The fixation member 28 is formed in, for example, a frame shape. The fixation member 28 may be formed of, for example, a resin such as plastic or rubber. Furthermore, the fixation member 28 may be formed of a felt, an adhesive, or a foam.

The mount member 22, the adhesive layer 24, the intermediate layer 32, the adhesive member 26, and the fixation member 28 are members that are connected to the pair of glass plates 30 so as to be able to directly or indirectly transmit the vibration and serve as influencing factors (hereinafter, referred to as “influencing factor members”) that affect vibration properties of the glass plates 30 in accordance with their temperatures. The mount member 22, the adhesive layer 24, the intermediate layer 32, the adhesive member 26, and the fixation member 28 are examples of the “influencing factor members” in the present disclosure.

Although examples of the influencing factor members listed here include the mount member 22, the adhesive layer 24, the intermediate layer 32, the adhesive member 26, and the fixation member 28, the glass diaphragm module 14 further includes a plurality of other influencing factor members. For example, the glass diaphragm module 14 includes a component and the like constituting a part of the exciter 20 as an example of the influencing factor members. Examples of the component corresponding to the influencing factor member include an adhesive member, an adhesive tape, a plastic, cloth, or paper spring, a plastic or fiber damper, a cover film, a felt, and a rubber component. The influencing factor members are, for example, members formed of materials with high rates of change in mechanical characteristics (for example, elastic moduli, attenuation rates, and the like) with respect to a change in temperature with respect to the glass plates 30.

As described above, the glass diaphragm module 14 includes many influencing factor members. There is a concern that if the mechanical characteristics of the influencing factor members change in accordance with the temperature, frequency response of the influencing factor members may change, vibration characteristics (for example, acceleration, an amplitude value, or the like of vibration for each frequency) of the glass plates 30 may be affected, and performance of the glass diaphragm module 14 may thus change. In other words, there is a concern that an error may occur between sound assumed to be emitted from the glass plates 30 in a case where a control signal is input to the exciter 20 and sound actually emitted from the glass plates 30. In particular, in a case where the glass diaphragm module 14 is applied to the roof glass 12G, a temperature rise due to solar radiation from the sun 34 is severe, and there is thus a concern of an increase in error. Therefore, it is required that a change in performance of the glass diaphragm module 14 in accordance with the temperature can be curbed. Therefore, in order to curb the change in performance of the glass diaphragm module 14 in accordance with the temperature, the glass diaphragm module 14 and the control device 16 are configured as follows in the first embodiment.

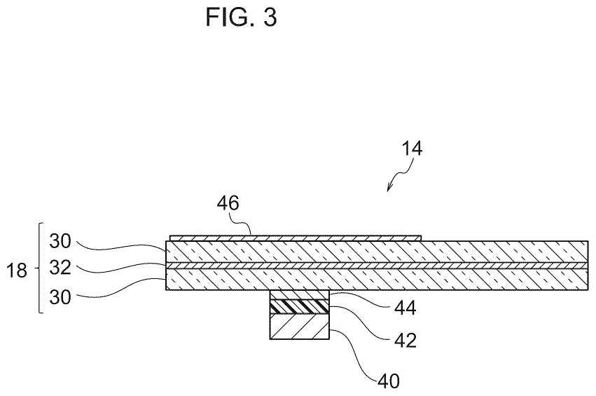

FIG. 3 illustrates another part (that is, a part different from the part where the exciter 20 is disposed) of the glass diaphragm module 14 according to the first embodiment. The glass diaphragm module 14 includes a temperature sensor 40. The temperature sensor 40 is, for example, a contact-type temperature sensor and is provided on the glass diaphragm 18 in the glass diaphragm module 14. Specifically, the mount member 42 is fixed to the main surface of the glass diaphragm 18 on the one side via the adhesive layer 44, and the temperature sensor 40 is fixed to the surface of the mount member 42 on the side opposite to the side of the glass diaphragm 18. Although the temperature sensor 40 may be glued by a typical method such as an adhesive, a pressure-sensitive adhesive, solder, or the like to the glass diaphragm 18, it is more preferable that the temperature sensor 40 can be simply detached from the glass diaphragm 18. For example, the temperature sensor 40 may be fixed to the mount member 42 in a replaceable manner by a fastening component such as a bolt, a screw, a pin, a key, a rivet, or a clip. Note that the temperature sensor 40 may be fixed to the main surface of the glass diaphragm 18 on the one side with the mount member 42 and the adhesive layer 44 omitted.

The temperature sensor 40 is preferably disposed at a position where the temperature sensor 40 is not directly affected by the solar radiation (for example, a position where the temperature sensor 40 is covered with a cover, an exterior panel, or the like). Also, the glass diaphragm 18 may be provided with a coating film 46 that shields the solar light such that the coating film 46 covers the temperature sensor 40. The coating film 46 may be provided on the indoor space side or may be provided on the outdoor space side.

The temperature sensor 40 detects the temperature of the glass diaphragm 18 and outputs a temperature detection signal in accordance with the detected temperature. The temperature sensor 40 may be an electric temperature sensor or a mechanical temperature sensor. Examples of the electric temperature sensor include a resistance temperature detector (RTD), a thermistor, a thermocouple, and an integrated circuit (IC) temperature sensor. Examples of the resistance temperature detector include a linear resistor. Examples of the thermistor include a negative temperature coefficient (NTC) thermistor and a positive temperature coefficient (PTC) thermistor. Examples of the mechanical temperature sensor include temperature sensitive ferrite and a thermal expansion-type temperature sensor. Examples of the thermal expansion-type temperature sensor include bimetal.

The thermal conductivity of the adhesive layer 44 and the mount member 42 is preferably equal to or greater than the thermal conductivity (about 0.94 W/(mK)) of the glass plate 30, is more preferably equal to or greater than 1.2 W/(mK), and is more preferably equal to or greater than 2.0 W/(mK). However, in a case where the thermal conductivity of the adhesive layer 44 and the mount member 42 is lower than the above-mentioned thermal conductivity, it is possible to secure the temperature measurement function of the temperature sensor 40 by reducing the thickness of the adhesive layer 44. The thickness of the adhesive layer 44 is equal to or less than 3 mm, is more preferably equal to or less than 2 mm, and is further preferably equal to or less than 1 mm. Furthermore, the thickness of the adhesive layer 44 is preferably equal to or less than 0.5 mm and is particularly preferably equal to or less than 0.2 mm. The lower limit value of the thickness of the adhesive layer 44 may be set in consideration of a yield at the time of manufacturing or the like.

FIG. 4 illustrates a hardware configuration of the control system S according to the first embodiment. The control system S includes a noise detection device 48 in addition to the glass diaphragm module 14, the control device 16, and the temperature sensor 40 described above. The noise detection device 48 may be provided in either the indoor space or the outdoor space. The noise detection device 48 is, for example, a microphone, an acceleration sensor, or the like. The acceleration sensor may be installed in a vehicle body of the vehicle 10. The noise detection device 48 detects sound or vibration and outputs a reference signal in accordance with the detected result.

The control device 16 includes a central processing unit (CPU) 50, a read only memory (ROM) 52, a random access memory (RAM) 54, a storage 56, an input/output interface (I/F) 58, an A/D conversion circuit 60, an external I/F 62, and a control circuit 64.

Note that the control device 16 may be implemented by a part of an electronic control unit (ECU) which is a vehicle control computer, or may be implemented by an in-vehicle computer which is different from the ECU. The control device 16 is an example of a “computer” in the present disclosure.

The CPU 50, the ROM 52, the RAM 54, and the input/output I/F 58 are connected to each other via a bus 66. The A/D conversion circuit 60, the external I/F 62, the control circuit 64, and the storage 56 are connected to the input/output I/F 58.

The A/D conversion circuit 60 is electrically connected to the noise detection device 48. The A/D conversion circuit 60 generates a digital reference signal through A/D conversion of an analog reference signal input from the noise detection device 48. The external I/F 62 is communicably connected to the temperature sensor 40. In a case where the temperature sensor 40 generates an analog temperature detection signal, the external I/F 62 may have an A/D conversion circuit that A/D converts the analog temperature detection signal to thereby generate a digital temperature detection signal.

The control circuit 64 is electrically connected to the exciter 20 of the glass diaphragm module 14. The control circuit 64 D/A converts a digital control signal input from the CPU 50 and outputs an analog control signal to the exciter 20. In this manner, the exciter 20 vibrates in accordance with the control signal, and sound corresponding to the control signal is generated from the glass diaphragm module 14.

The CPU 50 executes various programs. Specifically, the CPU 50 reads programs stored in the ROM 52 or the storage 56 and executes the programs using the RAM 54 as a work area. Then, the CPU 50 performs various types of arithmetic processing in accordance with the programs.

The ROM 52 stores various programs and various kinds of data. The RAM 54 temporarily stores the programs or the data as a work area. The storage 56 is configured of a recording medium such as a hard disk drive (HDD), a solid state drive (SSD), or a flash memory. The storage 56 stores various programs including an operating system and various kinds of data for the arithmetic processing.

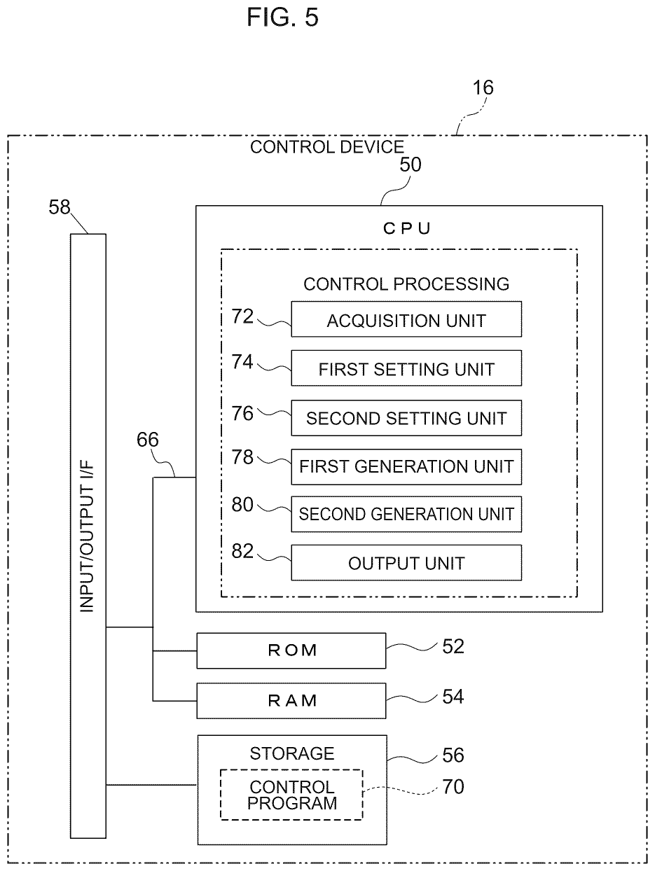

FIG. 5 illustrates a functional configuration of the control device 16 according to the first embodiment. The storage 56 stores a control program 70. The control program 70 is an example of a “program” and a “computer program product” in the present disclosure. Note that the control program 70 may be stored in the ROM 52. The CPU 50 reads the control program 70 and executes the control program 70 using the RAM 54 as a work area. Then, the CPU 50 executes control processing for controlling the glass diaphragm module 14 in accordance with the control program 70. The control processing is executed by the CPU 50 operating as an acquisition unit 72, a first setting unit 74, a second setting unit 76, a first generation unit 78, a second generation unit 80, and an output unit 82 in accordance with the control program 70. The first generation unit 78 and the second generation unit 80 are an example of a “generation unit” in the present disclosure. The first setting unit 74 and the second setting unit 76 are an example of a “setting unit” in the present disclosure.

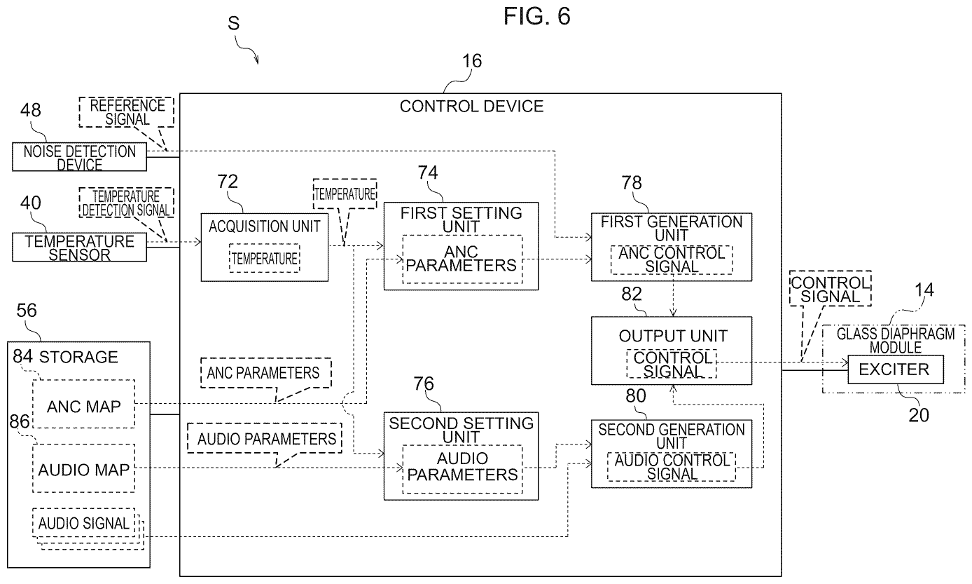

FIG. 6 illustrates operations of the control device 16 according to the first embodiment. The acquisition unit 72 acquires the temperature of the glass diaphragm module 14 on the basis of a temperature detection signal input from the temperature sensor 40 to the control device 16. The temperature of the glass diaphragm module 14 is an example of “temperature-related information”, “information obtained from the glass diaphragm module”, and “information detected by a temperature sensor” in the present disclosure.

The storage 56 stores an ANC map 84 indicating a relationship between the temperature of the glass diaphragm module 14 and parameters for active noise cancellation (ANC) (hereinafter, referred to as “ANC parameters”). In addition, the storage 56 stores an audio map 86 indicating a relationship between the temperature of the glass diaphragm module 14 and parameters for audio (hereinafter, referred to as “audio parameters”). The ANC map 84 is an example of “relationship information” in the present disclosure, and the ANC parameters are an example of “parameters” in the present disclosure. The audio map 86 is an example of “relationship information” in the present disclosure, and the audio parameters are an example of “parameters” in the present disclosure.

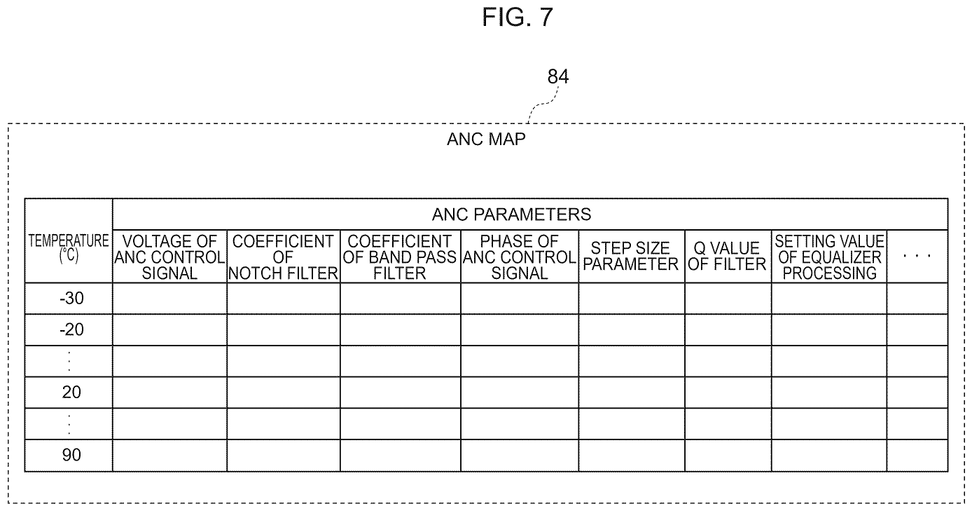

FIG. 7 illustrates the ANC map 84 according to the first embodiment. In the ANC map 84, the ANC parameters are defined for each temperature. As an example, the ANC parameters are set every 10° C. from- 30° C. to 90° C. The upper limit and the lower limit of the temperature may be any temperatures. In addition, the ANC parameters may be defined at any intervals of temperature. As an example, the ANC parameters include a voltage of an ANC control signal, a coefficient of a notch filter, a coefficient of a band pass filter, a phase of an ANC control signal, a step size parameter, a Q value of a filter, and a setting value of equalizer processing.

The coefficient of the notch filter is a filter coefficient applied to filter processing when the filter processing is performed on the ANC control signal using the notch filter. The resonance frequency of members constituting the glass diaphragm module 14 changes in accordance with the temperature. The notch filter is a filter for attenuating a component of the resonance frequency. The coefficient of the band pass filter is a filter coefficient applied to filter processing when the filter processing is performed on the ANC control signal using the band pass filter. It is possible to adjust a passing frequency band of the band pass filter for each temperature by changing the coefficient of the band pass filter for each temperature.

The phase of the ANC control signal changes for each temperature. It is possible to cause the phase of the ANC control signal to correspond to the temperature by selecting the phase in accordance with the temperature. The step size parameter is a factor related to a convergence coefficient in generating the ANC control signal. A Q value of the filter is sharpness applied to the notch filter and the band pass filter. The setting value of the equalizer processing is a value that defines an output level for each frequency of the ANC control signal when the equalizer processing is performed on the ANC control signal. The setting value of the equalizer processing may be arbitrarily set. The ANC parameters may not include at least any of the above parameters, and may include other parameters in addition to the above parameters.

Returning to FIG. 6, the first setting unit 74 acquires the ANC parameters corresponding to the temperature acquired by the acquisition unit 72 from the ANC map 84 and sets the acquired ANC parameters as parameters to be used for correction processing when the ANC control signal is generated by the first generation unit 78, which will be described later.

The first generation unit 78 generates the ANC signal for canceling inflow noise flowing into the indoor space from the outdoor space on the basis of the reference signal input from the noise detection device 48 to the control device 16.

Here, since vibration characteristics (for example, acceleration, an amplitude value, or the like of vibration for each frequency) of the glass plates 30 may have changed in accordance with the temperature of the glass diaphragm module 14 if ANC sound is generated from the glass diaphragm module 14 using the ANC signal as it is, there is a concern that an error may occur between sound assumed to be emitted from the glass plates 30 and sound actually emitted from the glass plates 30. Therefore, the first generation unit 78 executes correction processing based on the ANC parameters set by the first setting unit 74 on the generated ANC signal. The correction processing is processing including the filter processing using the notch filter and the band pass filter and the equalizer processing. Then, an ANC control signal which is a control signal corresponding to the temperature of the glass diaphragm module 14 is generated by the correction processing being executed on the ANC signal in this manner.

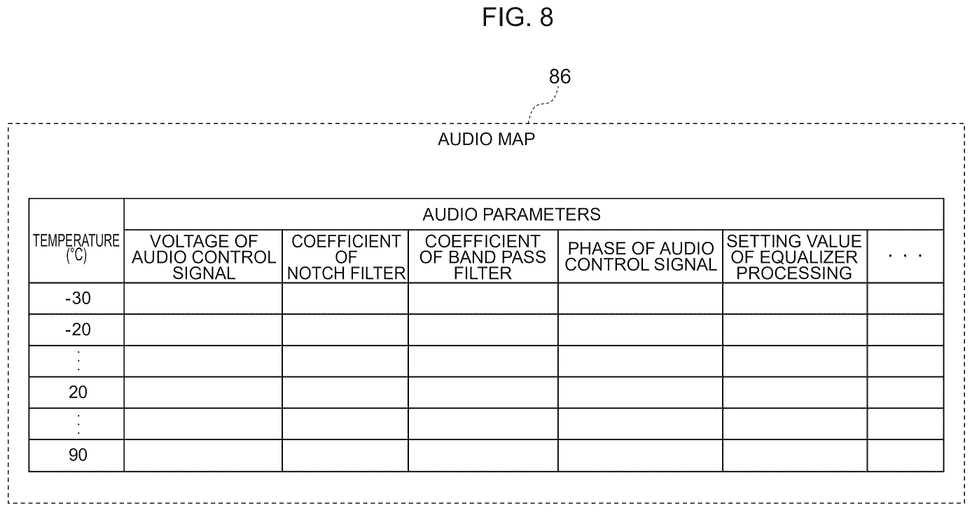

FIG. 8 illustrates the audio map 86 according to the first embodiment. In the audio map 86, the audio parameters are defined for each temperature. As an example, the audio parameters are set every 10° C. from −30° C. to 90° C. The upper limit and the lower limit of the temperature may be any temperatures. In addition, the audio parameters may be defined at any intervals of temperature. As an example, the audio parameters include a voltage of an audio control signal, a coefficient of a notch filter, a coefficient of a band pass filter, a phase of the audio control signal, and a setting value of equalizer processing.

The coefficient of the notch filter is a filter coefficient applied to filter processing when the filter processing is performed on the audio control signal using the notch filter. The coefficient of the band pass filter is a filter coefficient applied to filter processing when the filter processing is performed on the audio control signal using the band pass filter. The setting value of the equalizer processing is a value that defines an output level for each frequency of the audio control signal when the equalizer processing is performed on the audio control signal. The audio parameters may not include at least any of the above parameters, and may include other parameters in addition to the above parameters.

Returning to FIG. 6, the second setting unit 76 acquires the audio parameters corresponding to the temperature acquired by the acquisition unit 72 from the audio map 86 and sets the acquired audio parameters as parameters to be used for correction processing when the audio control signal is generated by the second generation unit 80, which will be described later.

The storage 56 stores a plurality of audio signals. The audio signals are, for example, signals for causing the glass diaphragm module 14 to output arbitrary audio sound (for example, sound such as a music, environmental sound, pseudo noise). The second generation unit 80 acquires any audio signal among the plurality of audio signals stored in the storage 56 on the basis of, for example, a selection instruction given to the control signal by a user. Note that although an example in which the second generation unit 80 acquires an audio signal stored in the storage 56 is described here, the second generation unit 80 may acquire an audio signal downloaded from the Internet or may acquire an audio signal received from a television broadcast network or a radio broadcast network.

Here, since vibration characteristics (for example, acceleration, an amplitude value, or the like of vibration for each frequency) of the glass plates 30 may have changed in accordance with the temperature of the glass diaphragm module 14 if audio sound is generated from the glass diaphragm module 14 using the audio signal as it is in a manner similar to the case of the ANC signal, there is a concern that an error may occur between sound assumed to be emitted from the glass plates 30 and sound actually emitted from the glass plates 30. Therefore, the second generation unit 80 executes correction processing based on the audio parameters set by the second setting unit 76 on the acquired audio signal. The correction processing is processing including the filter processing using the notch filter and the band pass filter and the equalizer processing. Then, an audio control signal which is a control signal corresponding to the temperature of the glass diaphragm module 14 is generated by the correction processing being executed on the audio signal in this manner.

The output unit 82 generates a control signal including the ANC control signal and the audio control signal by performing processing of adding the ANC control signal generated by the first generation unit 78 and the audio control signal generated by the second generation unit 80, and outputs the generated control signal to the exciter 20 of the glass diaphragm module 14. In this manner, the exciter 20 vibrates in accordance with the control signal, and ANC sound corresponding to the ANC control signal and audio sound corresponding to the audio control signal are output from the glass diaphragm module 14.

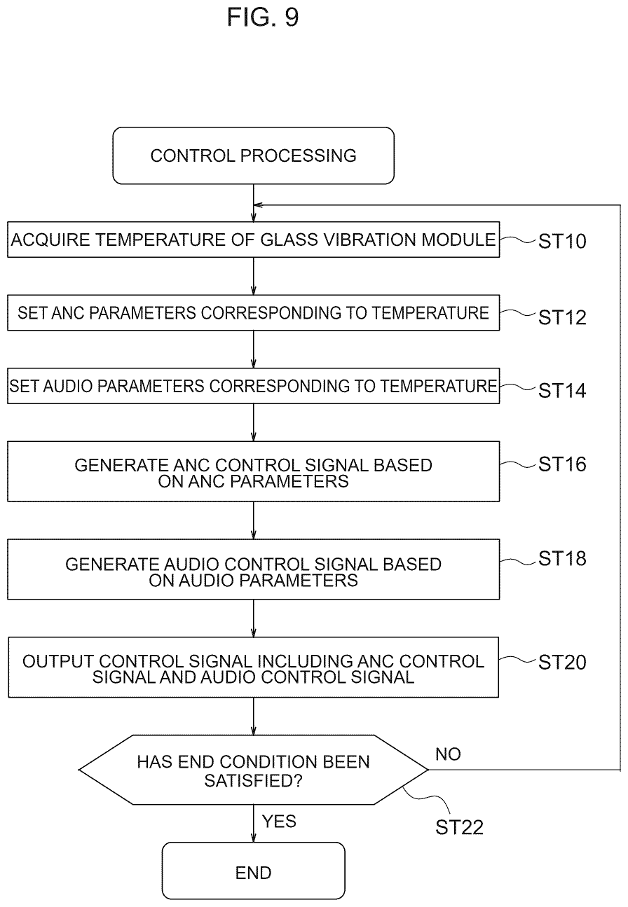

FIG. 9 illustrates a flow of control processing according to the first embodiment. The control device 16 executes a method of controlling the glass diaphragm module 14 by the control processing being executed. Hereinafter, a flow of the control processing which is an action of the control device 16 will be described.

First, the CPU 50 acquires the temperature of the glass diaphragm module 14 on the basis of the temperature detection signal input from the temperature sensor 40 to the control device 16 in Step ST10.

Then, in Step ST12, the CPU 50 acquires ANC parameters corresponding to the temperature acquired in Step ST10 from the ANC map 84 and sets the acquired ANC parameters as parameters to be used for correction processing when an ANC control signal is generated in Step ST16, which will be described later.

Then, in Step ST14, the CPU 50 acquires audio parameters corresponding to the temperature acquired in Step ST10 from the audio map 86 and sets the acquired audio parameters as parameters to be used for correction processing when an audio control signal is generated in Step ST18, which will be described later.

Next, in Step ST16, the CPU 50 generates an ANC signal on the basis of a reference signal input from the noise detection device 48 to the control device 16 and executes correction processing based on the ANC parameters set in Step ST12 on the ANC signal, thereby generating an ANC control signal, which is a control signal corresponding to the temperature of the glass diaphragm module 14.

Next, in Step ST18, the CPU 50 acquires an audio signal from the storage 56 or the like and executes correction processing based on the audio parameters set in Step ST14 on the audio signal, thereby generating an audio control signal, which is a control signal corresponding to the temperature of the glass diaphragm module 14.

Then, in Step ST20, the CPU 50 performs processing of adding the ANC control signal generated in Step ST16 and the audio control signal generated in Step ST18 to generate a control signal including the ANC control signal and the audio control signal, and outputs the generated control signal to the exciter 20 of the glass diaphragm module 14. In this manner, the exciter 20 vibrates in accordance with the control signal, and ANC sound corresponding to the ANC control signal and audio sound corresponding to the audio control signal are output from the glass diaphragm module 14.

Next, in Step ST22, the CPU 50 determines whether or not an end condition for ending the control processing has been satisfied. Examples of the end condition include a condition that an instruction to end the control processing from the user has been input to the control device 16. In a case where the end condition has not been satisfied, the control processing returns to Step ST10. In a case where the end condition has been satisfied, the control processing is ended.

As described above in detail, the CPU 50 sets the ANC parameters and the audio parameters on the basis of the temperature of the glass diaphragm module 14 and generates the ANC control signal and the audio control signal on the basis of the set ANC parameters and audio parameters in the first embodiment. Then, the CPU 50 generates the control signal including the ANC control signal and the audio control signal and outputs the generated control signal to the exciter 20 of the glass diaphragm module 14. Therefore, since the ANC control signal and the audio control signal are generated on the basis of the ANC parameters and the audio parameters corresponding to the temperature of the glass diaphragm module 14 even if the vibration characteristics (for example, acceleration, an amplitude value, or the like of the vibration for each frequency) of the glass plates 30 have changed in accordance with the temperature of the glass diaphragm module 14, it is possible to curb occurrence of an error between sound assumed to be emitted from the glass plates 30 and sound actually emitted from the glass plates 30. In other words, it is possible to curb a change in performance of the glass diaphragm module 14 in accordance with the temperature.

Also, the control system S includes the temperature sensor 40, and the CPU 50 acquires the temperature of the glass diaphragm module 14 on the basis of the temperature detection signal input from the temperature sensor 40 to the control device 16. Therefore, it is possible to set the ANC parameters and the audio parameters with high accuracy in accordance with the temperature of the glass diaphragm module 14.

In addition, since the temperature sensor 40 is used to acquire the temperature of the glass diaphragm module 14, it is possible to acquire the temperature of the glass diaphragm module 14 with high accuracy with a simple configuration.

In addition, the storage 56 stores the ANC map 84 and the audio map 86, and the CPU 50 acquires the ANC parameters and the audio parameters on the basis of the temperature of the glass diaphragm module 14 from the ANC map 84 and the audio map 86. Therefore, it is possible to set the ANC parameters and the audio parameters with high accuracy in accordance with the temperature of the glass diaphragm module 14.

Also, the ANC parameters include the voltage of the ANC control signal, the coefficient of the notch filter, the coefficient of the band pass filter, the phase of the ANC control signal, the step size parameter, and the Q value of the filter, and the setting value of the equalizer processing. Therefore, it is possible to generate the ANC control signal with high accuracy in accordance with the temperature of the glass diaphragm module 14 by executing the correction processing based on the ANC parameters on the ANC signal.

Moreover, the audio parameters include the voltage of the audio control signal, the coefficient of the notch filter, the coefficient of the band pass filter, the phase of the audio control signal, and the setting value of the equalizer processing. Therefore, it is possible to generate the audio control signal with high accuracy corresponding to the temperature of the glass diaphragm module 14 by executing the correction processing based on the audio parameters on the audio control signal.

Note that although both the ANC control signal and the audio control signal are generated in the first embodiment, only any one of the ANC control signal and the audio control signal may be generated. Then, only any one of the ANC control signal and the audio control signal may be output to the glass diaphragm module 14.

Although the glass diaphragm module 14 is applied to the roof glass 12G in the first embodiment, the glass diaphragm module 14 may be applied to another glass provided in the vehicle 10 other than the roof glass 12G. In addition, the glass diaphragm module 14 may be applied to a plurality of glasses other than one glass.

For example, the glass diaphragm module 14 may be applied to side door glasses such as the front side window glasses 12B or the rear side window glasses 12C. Such side door glasses are provided with members such as molding materials made of a resin, rubber materials holding the side door glasses, intermediate layers, and other resin members constituting the doors as influencing factor members that affect the vibration characteristics of the glass plates 30. There is a concern that if the temperatures of the influencing factor members change and mechanical characteristics thereof change, the vibration characteristics (for example, acceleration, an amplitude value, or the like for each frequency) of the glass plates 30 are affected, and performance of the glass diaphragm module 14 may thus change. However, it is possible to curb a change in performance of the glass diaphragm module 14 in accordance with the temperature even in the case where the glass diaphragm module 14 is applied to the side door glasses similarly to the case where the glass diaphragm module 14 is applied to the roof glass 12G in the first embodiment.

In addition, the glass diaphragm module 14 may be applied to the rear window glass 12D. Since the rear window glass 12D is inclined as compared with the side door glasses, a temperature rise due to solar radiation is severe similarly to the roof glass 12G. However, it is possible to curb a change in performance of the glass diaphragm module 14 in accordance with the temperature even in the case where the glass diaphragm module 14 is applied to the rear window glass 12D similarly to the case where the glass diaphragm module 14 is applied to the roof glass 12G in the first embodiment.

Furthermore, the control system S is applied to the vehicle 10 which is a passenger car as an example in the first embodiment. However, the control system S may be applied to a vehicle such as a shared-ride car, a cargo car, a special purpose car, or a construction machine in addition to the passenger car. In addition, the vehicle to which the control system S is applied may be an internal combustion engine vehicle using an internal combustion engine as a drive source, a hybrid vehicle using an internal combustion engine and a rotating electric machine as drive sources, or an electric vehicle using a rotating electric machine as a drive source. Furthermore, the control system S may be applied to a moving body such as an aircraft, a helicopter, a drone, or a ship in addition to a vehicle.

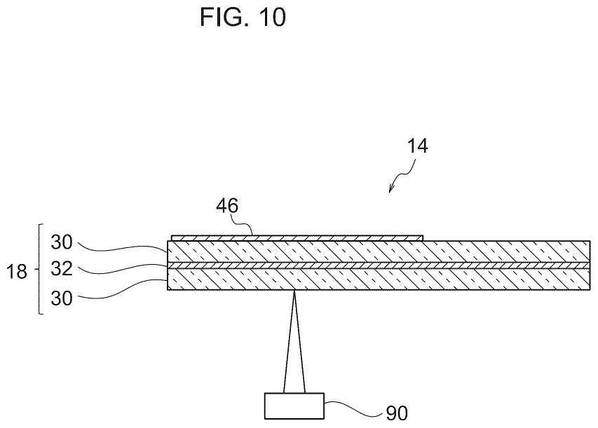

FIG. 10 illustrates a modification example of the glass diaphragm module 14 according to the first embodiment. In the present modification example, a temperature sensor 90 is used instead of the temperature sensor 40 (see FIG. 3). As an example, the temperature sensor 90 is a non-contact-type temperature sensor and is provided to face the glass diaphragm 18. Examples of the non-contact-type temperature sensor include an infrared sensor. Examples of the infrared sensor include a thermal (non-cooling-type) infrared sensor and a quantum (cooling-type) infrared sensor.

The temperature sensor 90 is preferably disposed at a position where the temperature sensor 90 is not directly affected by the solar radiation (for example, a position where the temperature sensor 90 is covered with a cover, an exterior panel, or the like). Also, the glass diaphragm 18 may be provided with a coating film 46 that shields the solar light such that the coating film 46 covers the temperature sensor 90. The coating film 46 may be provided on the indoor space side or may be provided on the outdoor space side.

The distance between the temperature sensor 90 and the glass diaphragm 18 is preferably as short as possible since the shorter the distance is, the higher the temperature detection accuracy of the glass diaphragm 18 is. The distance between temperature sensor 90 and glass diaphragm 18 is preferably equal to or less than 500 mm and is more preferably equal to or less than 300 mm. Furthermore, the distance between the temperature sensor 90 and the glass diaphragm 18 is preferably equal to or less than 200 mm and is particularly preferably equal to or less than 100 mm. Since there is a concern that if the distance between the temperature sensor 90 and the glass diaphragm 18 is excessively short, the temperature detection accuracy may decrease, the distance between the temperature sensor 90 and the glass diaphragm 18 is preferably at least equal to or greater than 1 mm, is more preferably equal to or greater than 3 mm, and is further preferably equal to or greater than 5 mm.

### Second Embodiment

Next, a second embodiment of the present disclosure will be described.

In the second embodiment, the following configurations are added to the control system S in the first embodiment.

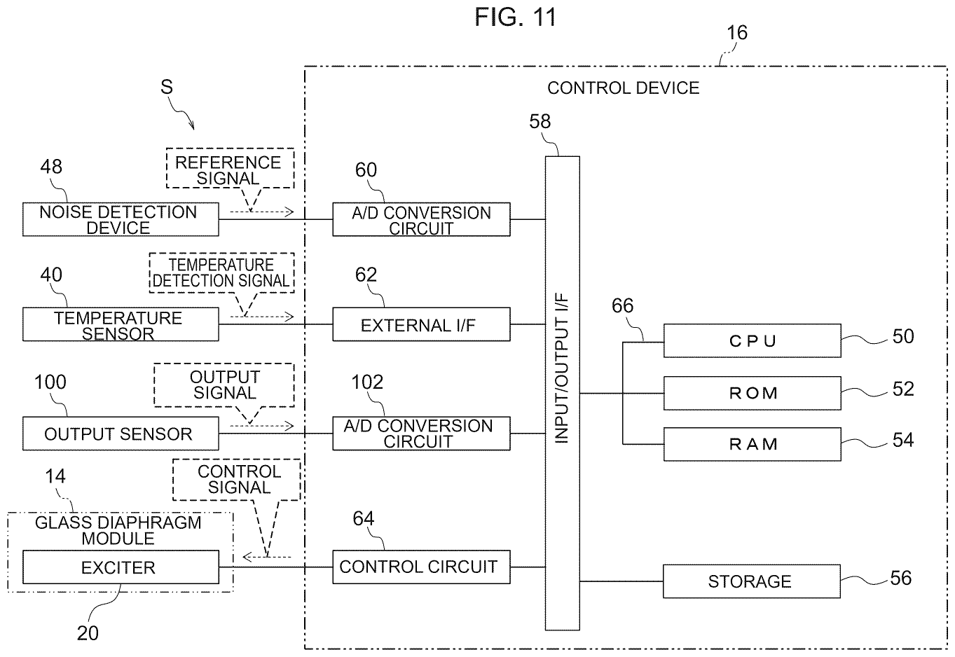

FIG. 11 illustrates a hardware configuration of a control system S according to the second embodiment. The control system S additionally includes an output sensor 100. As an example, the output sensor 100 is a microphone, detects sound generated from a glass diaphragm module 14, and outputs an output signal in accordance with the detected sound. The output sensor 100 is disposed in an indoor space in a state where the output sensor 100 faces the glass diaphragm module 14, for example. The output signal includes information (for example, acoustic information such as a frequency and a sound pressure) related to generated sound in a case where sound is generated from the glass diaphragm module 14 on the basis of a control signal.

A control device 16 additionally includes an A/D conversion circuit 102. The A/D conversion circuit 102 is connected to the output sensor 100 and an input/output I/F 58. The A/D conversion circuit 102 generates a digital output signal by A/D converting an analog output signal input from the output sensor 100.

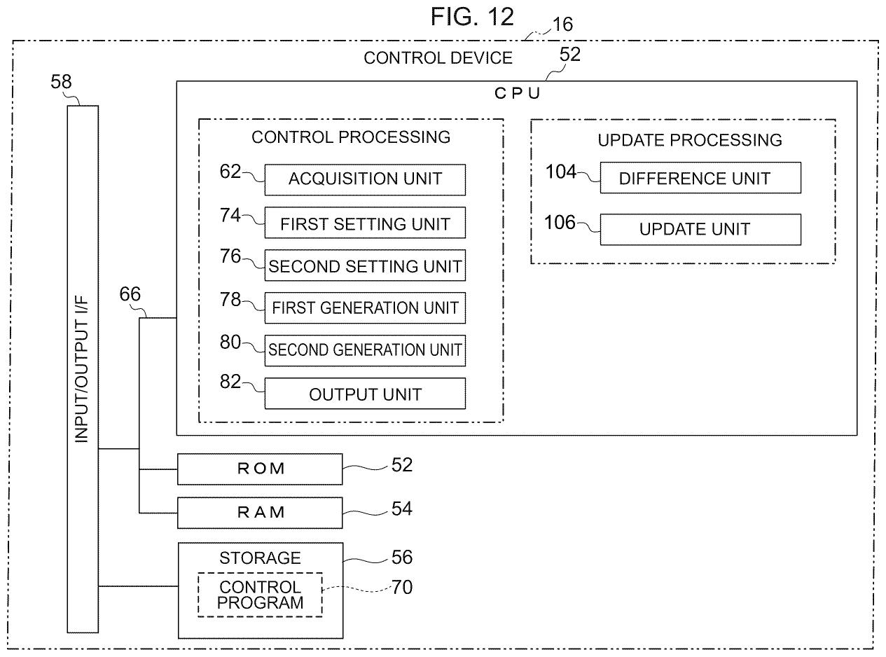

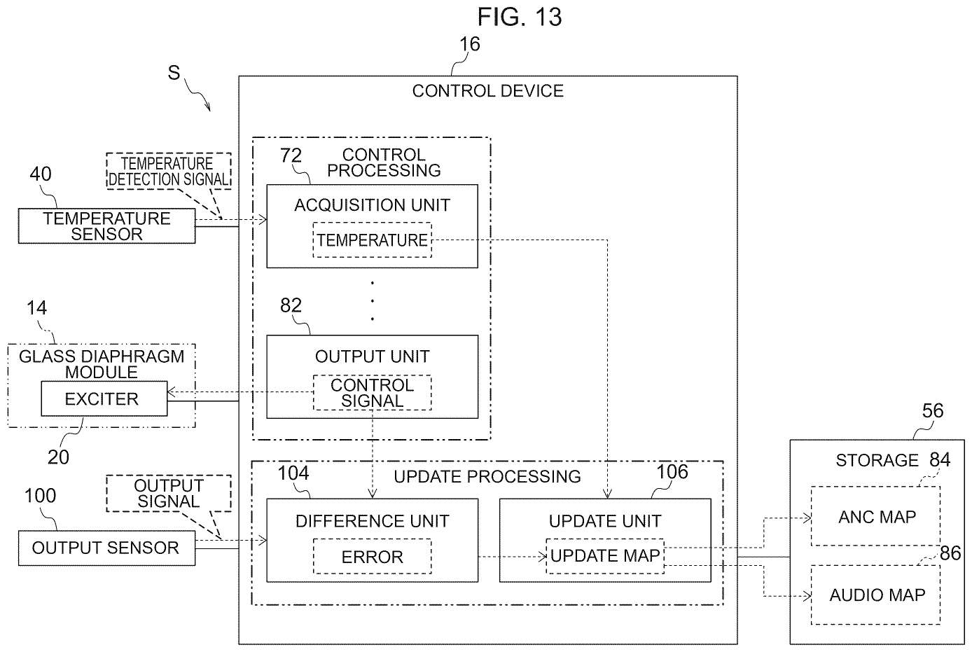

FIG. 12 illustrates a functional configuration of the control device 16 according to the second embodiment. A CPU 50 additionally executes update processing for updating an ANC map 84 and an audio map 86 (see FIG. 13) in accordance with a control program 70. The update processing is executed by the CPU 50 operating as a difference unit 104 and an update unit 106 in accordance with the control program 70.

FIG. 13 illustrates operations of the control device 16 according to the second embodiment. The update processing may be executed for each routine of control processing or may be executed for a plurality of routines of the control processing. The difference unit 104 acquires a control signal generated by an output unit 82, which is a functional unit of the control processing. In addition, in a case where sound is generated from the glass diaphragm module 14 on the basis of the control signal, the difference unit 104 acquires an output signal input from the output sensor 100 to the control device 16 in accordance with the generated sound. Then, the difference unit 104 derives an error between the control signal and the output signal by subtracting the output signal from the control signal.

The update unit 106 generates an update map on the basis of the temperature of the glass diaphragm module 14 acquired by an acquisition unit 72, which is a functional unit of the control processing, and the error derived by the difference unit 104. The update map is a map similar to the ANC map 84 and the audio map 86, and includes a map for updating the ANC map 84 and a map for updating the audio map 86.

The update unit 106 may generate the update map on the basis of the temperature of the glass diaphragm module 14 and the error derived by the difference unit 104 using a learning model trained by using teacher data including the temperature of the glass diaphragm module 14 and the error between the control signal and the output signal as input data and including ANC parameters and audio parameters as output data. Also, the update unit 106 may generate the update map on the basis of the temperature of the glass diaphragm module 14 and the error derived by the difference unit 104 using various functions. The update map is generated so as to reduce an error between the control signal and the output signal. Then, the update unit 106 updates the ANC map 84 and the audio map 86 stored in a storage 56 using the generated update map.

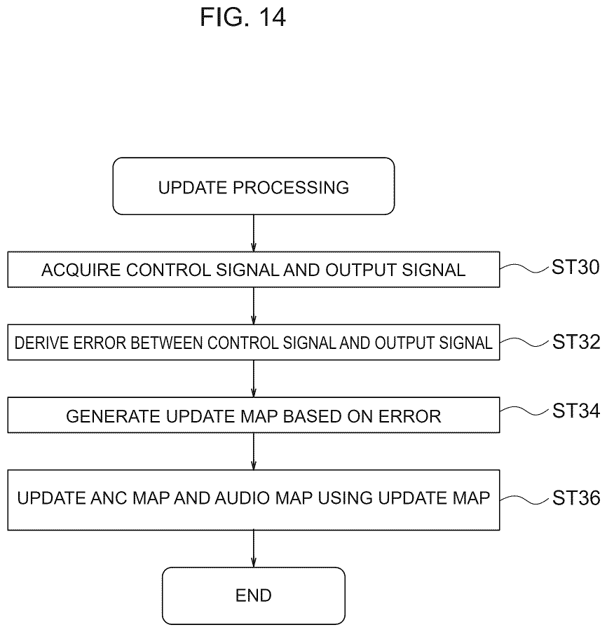

FIG. 14 illustrates a flow of the update processing according to the second embodiment. Hereinafter, the flow of the update processing which is an action of a control device 16 will be described.

First, in Step ST30, the CPU 50 acquires an output signal input from the output sensor 100 to the control device 16 and a control signal generated by the output unit 82, which is a functional unit of the control processing.

Next, in Step ST32, the CPU 50 derives an error between the control signal and the output signal by subtracting the output signal from the control signal using the control signal and the output signal acquired in Step ST30.

Then, in Step ST34, the CPU 50 generates the update map on the basis of the temperature of the glass diaphragm module 14 acquired by the acquisition unit 72, which is a functional unit of the control processing, and the error derived in Step ST32.

Then, in Step ST36, the CPU 50 updates the ANC map 84 and the audio map 86 stored in the storage 56 using the update map generated in Step ST34, and the update processing is then ended.

As described above in detail, the CPU 50 updates the ANC map 84 and the audio map 86 on the basis of the temperature of the glass diaphragm module 14, the control signal output to the glass diaphragm module 14, and the output signal input from the output sensor 100 to the control device 16 in accordance with the control signal in the second embodiment. Therefore, it is possible to reduce an error between the control signal and the output signal and thus an error between sound assumed to be emitted from glass plates 30 and sound actually emitted from the glass plates 30 by updating the ANC map 84 and the audio map 86 even in a case where mechanical characteristics of the influencing factor members have changed with time, for example.

Note that although the output sensor 100 is a microphone that detects sound generated from the glass diaphragm module 14 in the second embodiment, the output sensor 100 may be a vibration sensor that detects vibration generated in the glass diaphragm module 14. As the vibration sensor, an acceleration sensor that detects acceleration of the vibration generated in the glass diaphragm module 14 may be used. Furthermore, a value of vibration may be converted into a temperature on the basis of a predefined conversion formula, and the update map may be generated using the converted temperature in the case where the vibration sensor is used as the output sensor 100.

In addition, the output sensor 100 may be a voltage sensor that detects the voltage of an exciter 20 provided in the glass diaphragm module 14, or may be a resistance sensor that detects a resistance value that changes in accordance with the vibration of the glass diaphragm module 14. Furthermore, the voltage or the resistance value may be converted into a temperature on the basis of a predefined conversion formula, and the update map may be generated using the converted temperature in the case where the voltage sensor or the resistance sensor is used as the output sensor 100.

Although both the ANC map 84 and the audio map 86 are updated in the second embodiment, only any one of the ANC map 84 and the audio map 86 may be updated.

Furthermore, although the update processing is executed by the control device 16 in the second embodiment, the update processing may be executed by a server communicably connected to the control device 16.

### Third Embodiment

Next, a third embodiment of the present disclosure will be described.

In the third embodiment, the configuration of the control system S in the second embodiment is changed as follows.

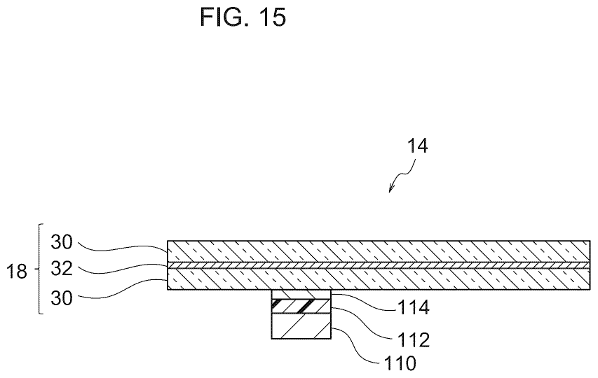

FIG. 15 illustrates another part (that is, a part different from a part where an exciter 20 is disposed) of a glass diaphragm module 14 according to the third embodiment. The glass diaphragm module 14 includes a vibration sensor 110 instead of the temperature sensor 40 (see FIG. 11). The vibration sensor 110 is, for example, a contact-type temperature sensor and is provided on a glass diaphragm 18 in the glass diaphragm module 14. Specifically, a mount member 112 is fixed to a main surface of the glass diaphragm 18 on one side via an adhesive layer 114, and the vibration sensor 110 is fixed to a surface of the mount member 112 on the side opposite to the side of the glass diaphragm 18. Although the vibration sensor 110 may be glued by a typical method such as an adhesive, a pressure-sensitive adhesive, solder, or the like to the glass diaphragm 18, it is more preferable that the vibration sensor 110 can be simply detached from the glass diaphragm 18. For example, the vibration sensor 110 may be fixed to the mount member 112 in a replaceable manner by a fastening component such as a bolt, a screw, a pin, a key, a rivet, or a clip. Note that the vibration sensor 110 may be fixed to the main surface of the glass diaphragm 18 on the one side with the mount member 112 and the adhesive layer 114 omitted.

The vibration sensor 110 detects vibration of the glass diaphragm 18 and outputs a vibration detection signal in accordance with the detected vibration. The vibration sensor 110 may detect a displacement amount, a speed, or an acceleration as a physical amount representing vibration. The contact-type vibration sensor may be a piezoelectric, conductive, or servo-type vibration sensor. In addition, an acceleration sensor may be used as the vibration sensor 110. The acceleration sensor may be a piezoelectric, servo, strain gauge, or semiconductor-type acceleration sensor. Furthermore, the vibration sensor 110 may be a non-contact-type vibration sensor. The non-contact-type vibration sensor may be an eddy current, capacitive, or optical-type vibration sensor.

There is a concern that if the adhesive layer 114 and the mount member 112 have high vibration absorption performance, an error may occur in the detection result of the vibration sensor 110. Therefore, the vibration absorption performance of the adhesive layer 114 and the mount member 112 is preferably set to such an extent that no error occurs in the detection result of the vibration sensor 110. Specifically, the Young's modulus of the mount member 112 is preferably equal to or greater than 1×10⁷ Pa, is more preferably equal to or greater than 1×10⁸ Pa, and is further preferably equal to or greater than 1×10⁹ Pa. From the viewpoint of easiness of machining of the mount member 112, the Young's modulus of the mount member 112 may be equal to or less than 1×10¹² Pa. Since a thick thickness of the adhesive layer 114 increases influences of the vibration absorption, the thickness of the adhesive layer 114 is preferably equal to or less than 5 mm, is more preferably equal to or less than 3 mm, and is further preferably equal to or less than 2 mm. The lower limit value of the thickness of the adhesive layer 114 may be set in consideration of a yield at the time of manufacturing or the like.

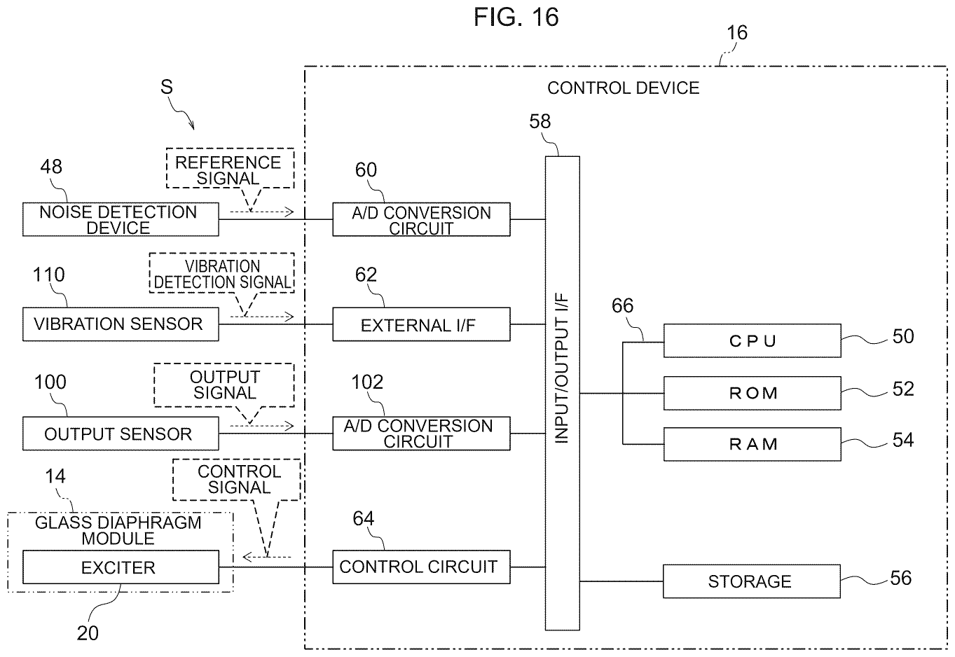

FIG. 16 illustrates a hardware configuration of the control system S according to the third embodiment. An external I/F 62 is communicably connected to the vibration sensor 110. In a case where the vibration sensor 110 generates an analog vibration detection signal, the external I/F 62 may include an A/D conversion circuit that A/D converts the analog vibration detection signal to generate a digital vibration detection signal. Furthermore, the control device 16 may include a fast Fourier transform (FFT) circuit for extracting a specific frequency component of the vibration detection signal.

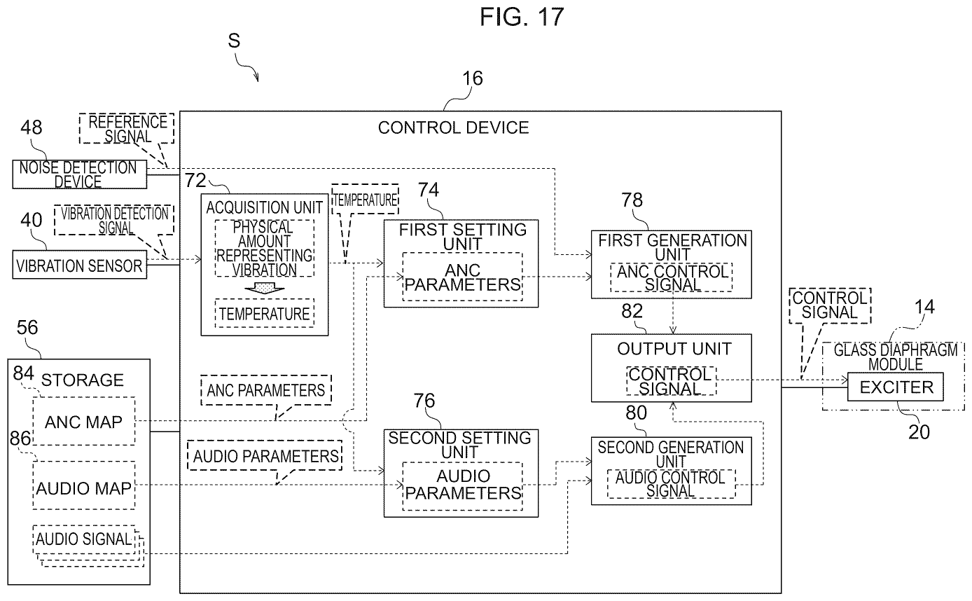

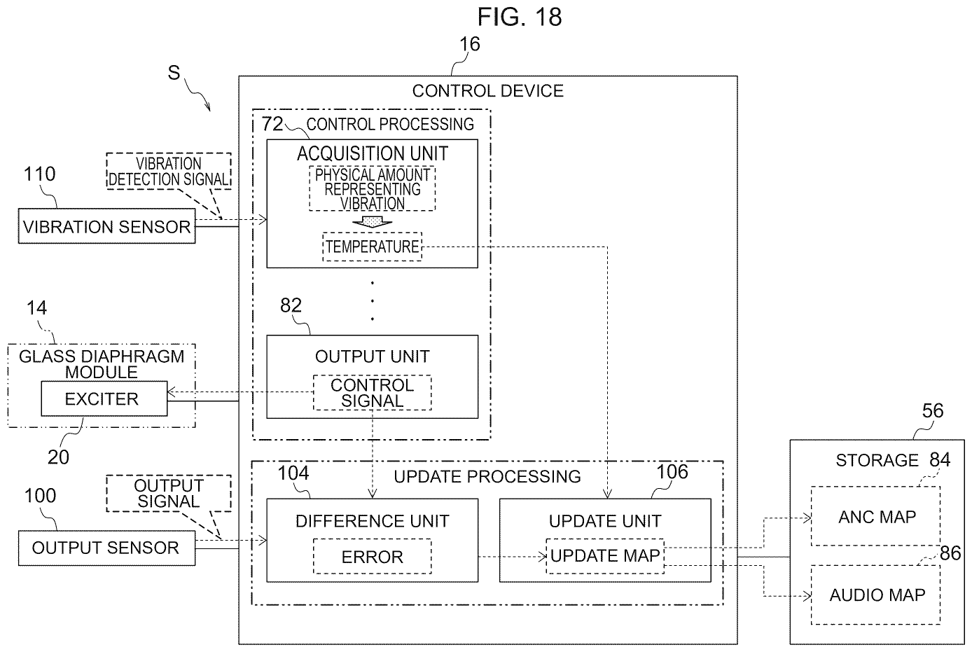

FIG. 17 illustrates operations related to control processing of the control device 16 according to the third embodiment, and FIG. 18 illustrates operations related to update processing of the control device 16 according to the third embodiment. An acquisition unit 72 acquires a physical amount representing vibration of the glass diaphragm module 14 on the basis of the vibration detection signal input from the vibration sensor 110 to the control device 16. Since the physical amount representing the vibration of the glass diaphragm module 14 changes in accordance with the temperature of the glass diaphragm module 14, the physical amount is correlated with the temperature of the glass diaphragm module 14. The physical amount representing the vibration of the glass diaphragm module 14 is an example of “temperature-related information”, “information obtained from a glass diaphragm module”, and “information detected by a vibration sensor” in the present disclosure. The acquisition unit 72 has a conversion formula for converting the physical amount representing the vibration of the glass diaphragm module 14 into the temperature of the glass diaphragm module 14 and estimates the temperature of the glass diaphragm module 14 from the physical amount representing the vibration of the glass diaphragm module 14 using the conversion formula.

In the third embodiment, operations of functional units (that is, a first setting unit 74, a second setting unit 76, a first generation unit 78, a second generation unit 80, an output unit 82, a difference unit 104, and an update unit 106) other than the acquisition unit 72 are similar to those in the second embodiment.

An ANC control signal and an audio control signal are generated on the basis of ANC parameters and audio parameters corresponding to the temperature of the glass diaphragm module 14 even if vibration characteristics (for example, acceleration, an amplitude value, or the like of vibration for each frequency) of glass plates 30 have changed in accordance with the temperature of the glass diaphragm module 14 in the third embodiment as well similarly to the first embodiment (see FIG. 17). Therefore, it is possible to curb occurrence of an error between sound assumed to be emitted from the glass plates 30 and sound actually emitted from the glass plates 30. In other words, it is possible to curb a change in performance of the glass diaphragm module 14 in accordance with the temperature.

Also, the control system S includes the vibration sensor 110, and a CPU 50 estimates the temperature of the glass diaphragm module 14 on the basis of the vibration detection signal input from the vibration sensor 110 to the control device 16. Therefore, it is possible to set the ANC parameters and the audio parameters with high accuracy in accordance with the temperature of the glass diaphragm module 14.

Also, since the vibration sensor 110 is used, it is possible to estimate the temperature of the glass diaphragm module 14 with high accuracy with a simple configuration without being affected by solar radiation.

Also, an ANC map 84 and an audio map 86 are updated on the basis of the temperature of the glass diaphragm module 14, the control signal output to the glass diaphragm module 14, and the output signal input from the output sensor 100 to the control device 16 in accordance with the control signal (see FIG. 18). Therefore, it is possible to reduce an error between the control signal and the output signal and thus an error between sound assumed to be emitted from glass plates 30 and sound actually emitted from the glass plates 30 by updating the ANC map 84 and the audio map 86 even in a case where mechanical characteristics of the influencing factor members have changed with time, for example.

Note that although the ANC map 84 defines ANC parameters for each temperature of the glass diaphragm module 14 in the third embodiment, the ANC map 84 may define ANC parameters for each physical amount representing the vibration of the glass diaphragm module 14. Then, the physical amount representing the vibration of the glass diaphragm module 14 may be used as it is without being converted into the temperature of the glass diaphragm module 14, and the ANC parameters may be set on the basis of the physical amount representing the vibration of the glass diaphragm module 14 from the ANC map 84.

Similarly, the audio map 86 may define audio parameters for each physical amount representing the vibration of the glass diaphragm module 14. Then, the physical amount representing the vibration of the glass diaphragm module 14 may be used as it is without being converted into the temperature of the glass diaphragm module 14, and the audio parameters may be set on the basis of the physical amount representing the vibration of the glass diaphragm module 14 from the audio map 86.

Although the physical amount representing the vibration of the glass diaphragm module 14 is converted into the temperature of the glass diaphragm module 14 and the update map is generated on the basis of the temperature of the glass diaphragm module 14 in the third embodiment, the physical amount representing the vibration of the glass diaphragm module 14 may be used as it is without being converted into the temperature of the glass diaphragm module 14, and the update map may be generated on the basis of the physical amount representing the vibration of the glass diaphragm module 14.

In the third embodiment, the control system S may include the temperature sensor 40 in the first embodiment and derive the temperature of the glass diaphragm module 14 on the basis of the detection result of the vibration sensor 110 and the detection result of the temperature sensor 40.

### Fourth Embodiment

Next, a fourth embodiment of the present disclosure will be described.

In the fourth embodiment, the configuration of the control system S in the third embodiment is changed as follows.

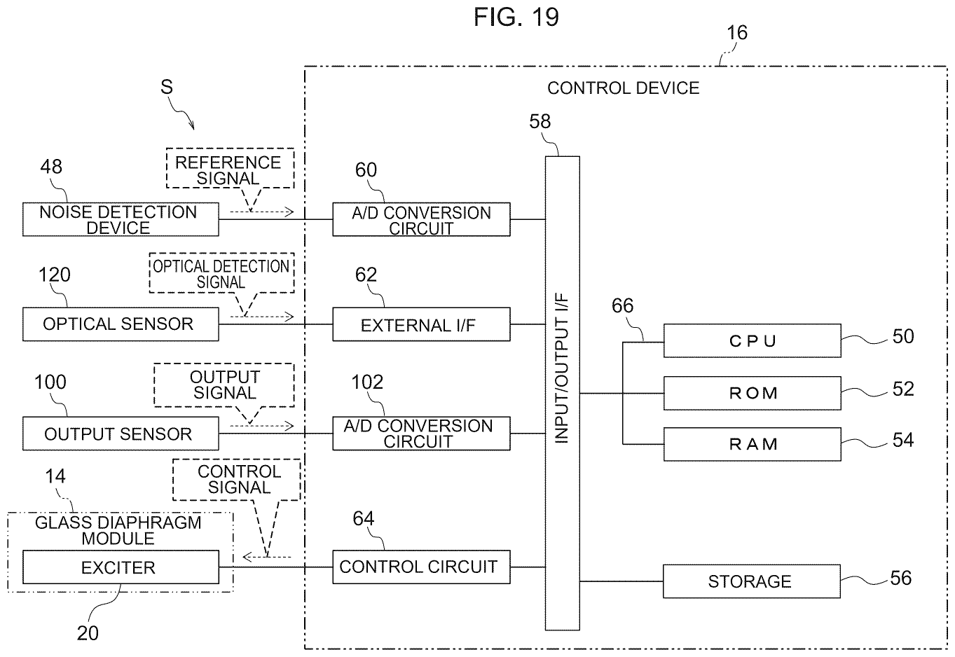

FIG. 19 illustrates a hardware configuration of a control system S according to the fourth embodiment. The control system S includes an optical sensor 120 instead of the vibration sensor 110 (see FIG. 16). The optical sensor 120 is a non-contact-type sensor, detects an optical physical amount of a glass diaphragm module 14, and outputs a detected optical detection signal. The optical sensor 120 may be any sensor as long as it is possible to detect the optical physical amount that is correlated with the temperature of the glass diaphragm module 14. For example, the optical sensor 120 may be an infrared camera that detects infrared rays emitted from the glass diaphragm module 14, a laser displacement meter that detects displacement of the glass diaphragm module 14, or the like. The optical physical amount of the glass diaphragm module 14 is an example of “temperature-related information”, “information obtained from a glass diaphragm module”, and “information detected by an optical sensor” in the present disclosure.

It is possible to obtain effects similar to those of the third embodiment in the fourth embodiment as well. Also, the optical physical amount of the glass diaphragm module 14 may be used as it is without being converted into the temperature of the glass diaphragm module 14, and ANC parameters may be set on the basis of the optical physical amount of the glass diaphragm module 14 from an ANC map 84 in the fourth embodiment as well. Similarly, audio parameters may be set on the basis of the optical physical amount of the glass diaphragm module 14 from an audio map 86. In addition, an update map may be generated on the optical physical amount of the glass diaphragm module 14.

### Fifth Embodiment

Next, a fifth embodiment of the present disclosure will be described.

In the fifth embodiment, the configuration of the control system S in the third embodiment is changed as follows.

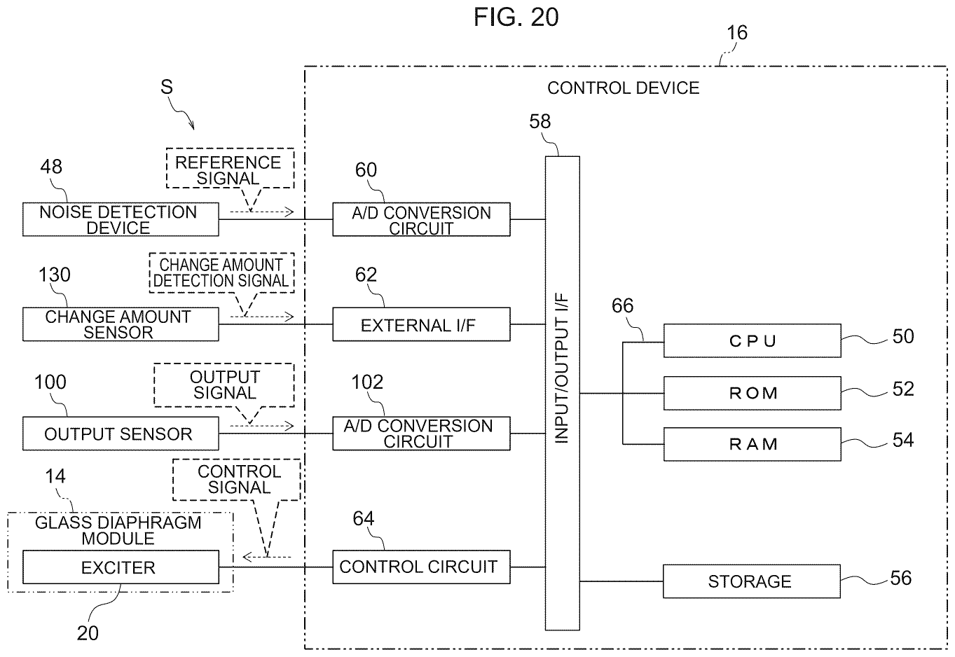

FIG. 20 illustrates a hardware configuration of a control system S according to the fifth embodiment. The control system S includes a change amount sensor 130 instead of the vibration sensor 110 (see FIG. 16). The change amount sensor 130 may be a contact-type sensor or a non-contact-type sensor. The change amount sensor 130 detects the physical change amount of the glass diaphragm module 14 and outputs a detected change amount detection signal.

The change amount sensor 130 may be any sensor as long as it is possible to detect the physical change amount that is correlated with the temperature of the glass diaphragm module 14. For example, the change amount sensor 130 may be a strain sensor that detects strain of the glass diaphragm module 14, a stress sensor that detects stress acting on the glass diaphragm module 14, or the like. In addition, the glass diaphragm module 14 may be provided with a color changing member with a color changing in accordance with the temperature. The change amount sensor 130 may be a color sensor that detects the color of the color changing member. The physical change amount of the glass diaphragm module 14 is an example of “temperature-related information”, “information obtained from a glass diaphragm module”, and “information detected by a change amount sensor” in the present disclosure.

It is possible to obtain effects similar to those of the third embodiment in the fifth embodiment as well. The physical change amount of the glass diaphragm module 14 may be used as it is without being converted into the temperature of the glass diaphragm module 14, and ANC parameters may be set on the basis of the physical change amount of the glass diaphragm module 14 from an ANC map 84 in the fifth embodiment as well. Similarly, audio parameters may be set on the basis of the physical change amount of the glass diaphragm module 14 from an audio map 86. In addition, an update map may be generated on the physical change amount of the glass diaphragm module 14.

### Sixth Embodiment

Next, a sixth embodiment of the present disclosure will be described.

In the sixth embodiment, the configuration of the control system S in the first embodiment is changed as follows.

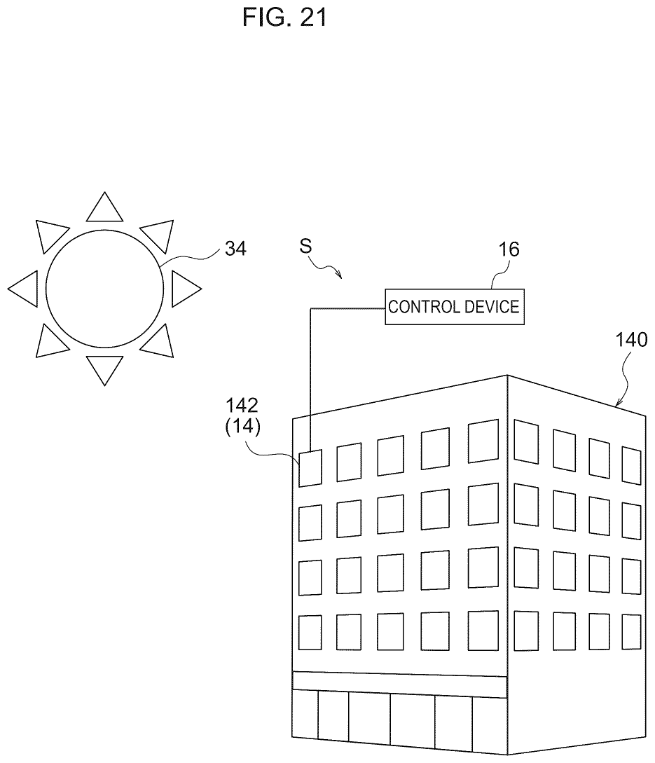

FIG. 21 illustrates a control system S according to the sixth embodiment. The control system S is applied to a building 140 as an example. The building 140 is an office building as an example. The building 140 includes a plurality of window glasses 142. A glass diaphragm module 14 can be applied to at least any window glass 142 among the plurality of window glasses 142 included in the building 140. The glass diaphragm module 14 may have a window frame or may include a fixing member or the like for fixing the window frame in addition to the window glass 142. The window frame may be formed of stainless steel, an aluminum alloy, or the like. The fixing member may be formed of a resin such as plastic or rubber.

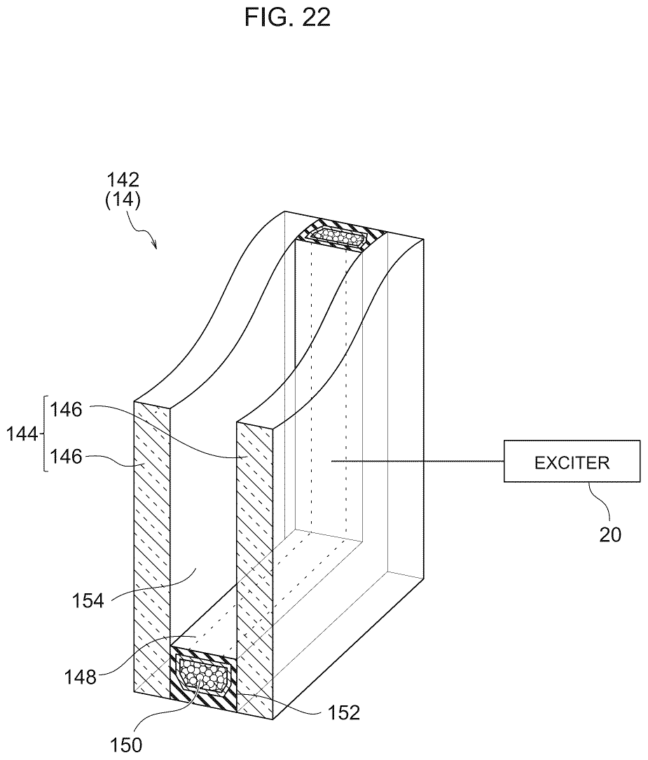

FIG. 22 illustrates the window glass 142 according to the sixth embodiment. The window glass 142 includes a glass diaphragm 144 and an exciter 20. The glass diaphragm 144 includes a pair of glass plates 146, a spacer 148, a moisture absorbing material 150, and a sealing material 152. The spacer 148 is provided between the pair of glass plates 146, and a hollow layer 154 is provided between the pair of glass plates 146. The spacer 148 is formed of a resin such as plastic or rubber, for example. The moisture absorbing material 150 is accommodated inside the spacer 148. The moisture absorbing material 150 is formed of, for example, calcium chloride. The sealing material 152 seals edges of the pair of glass plates 146. The sealing material 152 is formed of a resin such as plastic or rubber.

The spacer 148, the moisture absorbing material 150, and the sealing material 152 are influencing factor members that are connected such that the spacer 148, the moisture absorbing material 150, and the sealing material 152 can transmit vibration directly or indirectly to the pair of glass plates 146 and that affect vibration characteristics of the glass plates 146 in accordance with their temperatures. The spacer 148, the moisture absorbing material 150, and the sealing material 152 are examples of an “influencing factor member” in the present disclosure.

In this manner, the window glass 142 as the glass diaphragm module 14 includes many influencing factor members. There is a concern that if mechanical characteristics of the influencing factor members change in accordance with the temperature, frequency response of the influencing factor members may change, vibration characteristics (for example, acceleration, an amplitude value, or the like of vibration for each frequency) of the glass plates 146 may be affected, and performance of the glass diaphragm module 14 may thus change. In other words, there is a concern that an error may occur between sound assumed to be emitted from the glass plates 146 in a case where a control signal is input to the exciter 20 and sound actually emitted from the glass plates 146. In particular, in a case where the glass diaphragm module 14 is applied to the window glass 142 of the building 140, a temperature rise due to solar radiation from the sun 34 is severe, and there is thus a concern of an increase in error. Therefore, it is required that a change in performance of the glass diaphragm module 14 in accordance with the temperature can be curbed. Thus, a control device 16 similar to that of the first embodiment is applied to the window glass 142 as the glass diaphragm module 14 in the sixth embodiment.

An ANC control signal and an audio control signal are generated on the basis of ANC parameters and audio parameters corresponding to the temperature of the glass diaphragm module 14 even if vibration characteristics (for example, acceleration, an amplitude value, or the like of vibration for each frequency) of glass plates 146 have changed in accordance with the temperature of the glass diaphragm module 14 in the sixth embodiment as well similarly to the first embodiment (see FIG. 6). Therefore, it is possible to curb occurrence of an error between sound assumed to be emitted from the glass plates 146 and sound actually emitted from the glass plates 146. In other words, it is possible to curb a change in performance of the glass diaphragm module 14 in accordance with the temperature.

Note that at least any of the configurations in the second to fifth embodiments may be applied to the sixth embodiment.

Although the control system S is applied to the window glass 142 provided on an exterior wall of the building 140 as an example in the sixth embodiment, the control system S may be applied to a glass provided inside the building 140.

Furthermore, although the control system S is applied to an office building as an example in the sixth embodiment, the control system S may be applied to a building such as a residence or a commercial facility other than the office building. In addition, the control system S may be applied to a factory and attenuate noise leaking from the inside to the outside of the factory. In addition, the control system S may be applied to a sound insulation wall (soundproof wall) made of glass and installed beside a road to attenuate noise passing through the sound insulation wall.

Although the first to sixth embodiments of the present disclosure have been described above, it is a matter of course that various other modifications can be made to each of the above embodiments.

For example, although the CPU 50 has been exemplified in relation to the control device 16 in each of the above embodiments, at least one of other CPUs, at least one graphics processing unit (GPU), and/or at least one tensor processing unit (TPU) may be used instead of or in addition to the CPU 50.

Although the example in which the storage 56 stores the control program 70 in advance has been described in each of the above embodiments, the control program 70 may be stored in a portable non-transitory computer-readable storage medium (hereinafter, simply referred to as a “non-transitory storage medium”) such as a solid state drive (SSD) or a universal serial bus (USB) memory. Then, the control program 70 stored in the non-transitory storage medium may be installed in the control device 16.

In addition, a storage device of another computer, a server device, or the like connected to the control device 16 via a network may be caused to store the control program 70, and the control program 70 may be downloaded in response to a request from the control device 16 and may then be installed in the control device 16.

In addition, it is not necessary to cause the storage device of another computer, the server device, or the like connected to the control device 16 or the storage 56 to store the entire control program 70, and the storage device or the storage 56 may be caused to store a part of the control program 70.

Although the computer including the CPU 50, the ROM 52, the RAM 54, and the storage 56 has been exemplified in relation to the control device 16 in each of the above embodiments, a device including an application specific integrated circuit (ASIC), a field-programmable gate array (FPGA), and/or a programmable logic device (PLD) may be applied instead of the computer. In addition, a combination of a hardware configuration and a software configuration may be used instead of the computer.

In addition, various processors listed below may be used as hardware resources that execute the various kinds of processing described in each of the above embodiments. Examples of the processors include CPUs which are general-purpose processors functioning as hardware resources that execute various kinds of processing by executing software, that is, programs. In addition, examples of the processors include a dedicated electronic circuit which is a processor having a circuit configuration exclusively designed for executing specific processing, such as FPGA, PLD, or ASIC. Memories are built in or connected to all of these processors, and all of these processors execute various kinds of processing by using the memories.

The hardware resources executing various kinds of processing may be configured of one of these various processors or may be configured of a combination of two or more processors of the same type or different types (for example, a combination of a plurality of FPGAs or a combination of a CPU and an FPGA). In addition, the hardware resources executing the various kinds of processing may be one processor.

As an example in which the hardware resources are configured of one processor, there is a first mode in which the one processor is configured of a combination of one or more CPUs and software and the processor functions as the hardware resources for executing the various kinds of processing. There is a second mode using a processor that implements, by one integrated circuit (IC) chip, functions of the entire system including the plurality of hardware resources for executing various kinds of processing, like a system-on-a-chip (SoC) as a representative example. In this manner, the various kinds of processing are implemented by using the one or more various processors described above as the hardware resources.

Yet more specifically, it is possible to use an electronic circuit obtained by combining circuit elements such as semiconductor elements as a hardware structure of such various processors. In addition, the above various kinds of processing are merely example. Therefore, it is needless to say that unnecessary steps may be deleted, new steps may be added, or the processing order may be changed within a range not departing from the gist.

The present disclosure extends to any computer program products. The computer program products include products in any modes for providing programs. For example, the computer program products include a program provided through a network such as the Internet, a non-transitory computer-readable recording medium such as a CD-ROM, a DVD, and a USB memory storing the programs, and the like.

The contents described and illustrated above are detailed descriptions of parts according to the present disclosure and are merely examples of the present disclosure. For example, the above description regarding the configurations, functions, operations, and effects is a description regarding examples of the configurations, functions, operations, and effects of the parts according to the present disclosure. Therefore, it is needless to say that unnecessary parts may be deleted, new elements may be added, or replacement may be made with respect to the contents described and illustrated above within the scope not departing from the gist of the present disclosure. Furthermore, in order to avoid complication and to facilitate understanding of the parts according to the present disclosure, description regarding technical common knowledge and the like that do not require any particular description to enable the implementation of the present disclosure are omitted in the contents described and illustrated above.

All the documents, patent applications, and technical standards described in the present specification are incorporated herein by reference to the same extent as if each document, patent application, and technical standard were specifically and individually indicated to be incorporated by reference.

Hereinafter, supplementary notes relating to each of the above embodiments will be disclosed.

### (Supplementary Note 1)

A control device for a glass diaphragm module including:
a generation unit that generates a control signal for causing the glass diaphragm module to generate sound on the basis of parameters;
an output unit that outputs the control signal to the glass diaphragm module; and
a setting unit that sets the parameters on the basis of temperature-related information related to a temperature of the glass diaphragm module.

### (Supplementary Note 2)

The control device for a glass diaphragm module according to Supplementary Note 1, in which the temperature-related information includes information obtained from the glass diaphragm module.

### (Supplementary Note 3)

The control device for a glass diaphragm module according to Supplementary Note 1 or 2, in which the temperature-related information includes information detected by a temperature sensor.

### (supplementary Note 4)

The control device for a glass diaphragm module according to any one of Supplementary Notes 1 to 3, in which the temperature-related information includes information detected by a vibration sensor.

### (Supplementary Note 5)

The control device for a glass diaphragm module according to any one of Supplementary Notes 1 to 4, in which the temperature-related information includes information detected by an optical sensor.

### (supplementary Note 6)

The control device for a glass diaphragm module according to any one of Supplementary Notes 1 to 5, in which the temperature-related information includes information detected by a change amount sensor that detects a physical change amount.

### (Supplementary Note 7)

The control device for a glass diaphragm module according to any one of Supplementary Notes 1 to 6, in which the setting unit acquires the parameters on the basis of the temperature-related information from relationship information representing a relationship between the temperature-related information and the parameters.

### (Supplementary Note 8)

The control device for a glass diaphragm module according to Supplementary Note 7, including:
an update unit that updates the relationship information on the basis of the temperature-related information, the control signal, and an output signal in accordance with an output of the glass diaphragm module.

### (Supplementary Note 9)

The control device for a glass diaphragm module according to any one of Supplementary Notes 1 to 8, in which the parameters include at least any of a voltage of the control signal, a filter coefficient applied to filter processing on the control signal, a phase of the control signal, a step size parameter which is a factor related to a convergence coefficient in generating the control signal, sharpness applied to the filter processing, and a setting value of equalizer processing on the control signal.

### (Supplementary Note 10)

A control system including:
the control device for a glass diaphragm module according to any one of Supplementary Notes 1 to 9; and
the glass diaphragm module.

### (Supplementary Note 11)

The control system according to Supplementary Note 10,
in which the glass diaphragm module includes
glass plates,
an exciter that is connected to the glass plates, and
an influencing factor member that serves as an influencing factor influencing vibration characteristics of the glass plates in accordance with a temperature of the influencing factor member itself.

### (Supplementary Note 12)

The control system according to Supplementary Note 11, in which the influencing factor member is connected to be able to transmit vibration to the glass plates.

### (Supplementary Note 13)

A control method for a glass diaphragm module including:
generating a control signal for causing the glass diaphragm module to generate sound on the basis of parameters;
outputting the control signal to the glass diaphragm module; and
setting the parameters on the basis of temperature-related information related to a temperature of the glass diaphragm module.

### (Supplementary Note 14)

A control program that causes a computer to execute processing including:
generating a control signal for causing a glass diaphragm module to generate sound on the basis of parameters;
outputting the control signal to the glass diaphragm module; and
setting the parameters on the basis of temperature-related information related to a temperature of the glass diaphragm module.

### (Supplementary Note 15)

A computer program product that includes a control program that causes a computer to execute processing including:
generating a control signal for causing a glass diaphragm module to generate sound on the basis of parameters;
outputting the control signal to the glass diaphragm module; and
setting the parameters on the basis of temperature-related information related to a temperature of the glass diaphragm module.

1. A control device for a glass diaphragm module comprising:
a generation unit that generates a control signal for causing the glass diaphragm module to generate sound on the basis of parameters;
an output unit that outputs the control signal to the glass diaphragm module; and
a setting unit that sets the parameters on the basis of temperature-related information related to a temperature of the glass diaphragm module.

2. The control device for a glass diaphragm module according to claim 1, wherein the temperature-related information includes information obtained from the glass diaphragm module.

3. The control device for a glass diaphragm module according to claim 1, wherein the temperature-related information includes information detected by a temperature sensor.

4. The control device for a glass diaphragm module according to claim 1, wherein the temperature-related information includes information detected by a vibration sensor.

5. The control device for a glass diaphragm module according to claim 1, wherein the temperature-related information includes information detected by an optical sensor.

6. The control device for a glass diaphragm module according to claim 1, wherein the temperature-related information includes information detected by a change amount sensor that detects a physical change amount.

7. The control device for a glass diaphragm module according to claim 1, wherein the setting unit acquires the parameters on the basis of the temperature-related information from relationship information representing a relationship between the temperature-related information and the parameters.

8. The control device for a glass diaphragm module according to claim 7, comprising:
an update unit that updates the relationship information on the basis of the temperature-related information, the control signal, and an output signal in accordance with an output of the glass diaphragm module.

9. The control device for a glass diaphragm module according to claim 1, wherein the parameters include at least any of a voltage of the control signal, a filter coefficient applied to filter processing on the control signal, a phase of the control signal, a step size parameter which is a factor related to a convergence coefficient in generating the control signal, sharpness applied to the filter processing, and a setting value of equalizer processing on the control signal.

10. A control system comprising:
the control device for a glass diaphragm module according to claim 1; and
the glass diaphragm module.

11. The control system according to claim 10,
wherein the glass diaphragm module includes
glass plates,
an exciter that is connected to the glass plates, and
an influencing factor member that serves as an influencing factor influencing vibration characteristics of the glass plates in accordance with a temperature of the influencing factor member itself.

12. The control system according to claim 11, wherein the influencing factor member is connected to be able to transmit vibration to the glass plates.

13. A control method for a glass diaphragm module comprising:
generating a control signal for causing the glass diaphragm module to generate sound on the basis of parameters;
outputting the control signal to the glass diaphragm module; and
setting the parameters on the basis of temperature-related information related to a temperature of the glass diaphragm module.

14. A non-transitory computer-readable storage medium storing a control program that causes a computer to execute processing comprising:
generating a control signal for causing a glass diaphragm module to generate sound on the basis of parameters;
outputting the control signal to the glass diaphragm module; and
setting the parameters on the basis of temperature-related information related to a temperature of the glass diaphragm module.
